(19) United States
(12) Patent Application Publication
(10) Pub. No.: US 2008/0224000 A1
(43) Pub. Date: Sep. 18, 2008

(54) Tripod For Camera

(76) Inventor: Yongjian Yang, Guangdong Province (CN)

Correspondence Address: SCHMEISER, OLSEN & WATTS, 22 CENTURY HILL DRIVE, SUITE 302, LATHAM, NY, 12110, US

(21) Appl. No.: 12/065,524

(22) PCT Filed: Nov. 24, 2005
(86) PCT No.: PCT/CN05/01991

§ 371 Date: Mar. 3, 2008

(30) Foreign Application Priority Data
Sep. 20, 2005 (CN) 200510037323.9
Nov. 24, 2005 (CN) PCT/CN05/001991

(51) Int. Cl. F16B 7/14; F16M 11/32

(52) U.S. Cl. 248/188.5; 248/163.1

(57) ABSTRACT

A tripod for the camera is provided. The opening and closing mechanism for adjusting quickly the leg opening angle is provided between the leg tube base and the tripod body in the tripod. The inner expanding type of locking mechanism is provided between the tubes. The ratch in the tube is engaged with the pawl such that the opening angle of the leg of the tripod may be controlled. The taper screw is cooperated rotatablely with the taper nut within the tube such that the lock or the loose between the two leg tubes may be controlled. The adjustable turntable is provided on the top of the tripod central axis, and the withdrawing type of pothook is provided on the bottom thereof.

### TECHNICAL FIELDS OF THE INVENTION

The present invention relates to a tripod for video or camera, especially a kind of small size, lightweight, and convenient professional tripod for outdoors. It belongs to the technical fields of the photographic equipment.

### PRIOR ART OF THE INVENTION

Tripod for camera is usually needed when taking photos. The tripod generally consists of three legs. Each leg is composed of certain telescopic tubes. The legs will turn to open when the tripod in use. The legs will have to be opened to an optimum angle in order to make sure the tripod not being tipped over after the camera installed, especially when long lens is used. Also, the tubes have to be adjusted to fix the height of the tripod. In prior art, the tripod for camera includes a screw clip to control opening angle of the legs. This type of locking device is neither convenient nor insecure. Also there is no mechanism to control the flexibility of the tubes, as a result slippage may easily occur and it is hard to control the radial rotation of the legs, which bring inconvenient to the camera tripod user.

### PURPOSE OF THE INVENTION

The purpose of the present invention is to provide a tripod for camera. In the present invention, a trigger controlled opening and closing mechanism is provided for adjusting quickly the leg opening angle, and inner expanding type of locking mechanism is provided between the tubes, also telescopic central axis is provided. In the present invention, in order to make the operation conveniently and performance safely, pawl is provided to control the opening angle of the legs of the tripod, and taper screw is cooperated with the taper nut to connect and control the radial rotation of the legs.

### TECHNOLOGY OF THE INVENTION

The present invention, a tripod for camera is comprised of tripod body, tubes, tube bases, tube joints, turntable, central axis, elevator level, pothook. The tubes are connected to the tripod body and installed on the tube bases. The elevator lever of the central axis is installed and passed vertically through the tripod body. The elevator nut is mounted upon the tripod body, and the turntable is installed at the upper end of the tripod central axis. Wherein, between the leg tube base and the tripod body in the tripod the opening and closing mechanism for adjusting the leg opening angle is provided, between the tubes the inner expanding type of locking mechanism is provided. The opening and closing mechanism for adjusting the leg opening angle includes pawl, pawl axis, wrap for fixing the pawl, spring for fixing the pawl, handle, rocker, axis for handle and tube bases, wherein said pawl is sheathed on said pawl axis, and the pawl axis passes through the tripod body horizontally and parallels with the rocker. The rocker is installed with handle. Ratches are provided to match with the pawls on the tube base.

The inner expanding type of locking mechanism between the tubes is comprised of tube base, orientation ring, protective rubber sheath, tubes, tube screw, nut and nut cover. The tubes pass through the tube bases and connect with the tripod body. The taper nut is provided inside of the tubes, and tube screw is installed at the tube joints. The taper screw at the tube joints is cooperated rotatablely with the taper nut within the tube.

The central axis of the tripod has a telescopic construction of two or more segments, and passes through the center of the tripod body.

In the present invention, the turntable with scale is provided on the top of the tripod central axis, and the withdrawing type of pothook is provided on the bottom thereof.

In the present invention, the surfaces of both the metallic tubes and the central axis are covered with carbon fiber layers, which make them into carbon fiber strengthen metallic tubes.

The present invention works as below:
1. When need to open the tripod legs, first pull the handle, so the handle will drive the rocker to put up the pawl and make the legs dispread to a designated angle, the spring for the pawl will push the pawl back to the original status on the tube base, and prevent the tube from dispreading. When need to close the tripod legs, rotate the ratch on the tube base around the pawl, so the legs can be retrieved to closing status.
2. The taper screw is provided in the tube joint and cooperated with the taper nut within the tube; so that the telescopic connection between the tubes will limit the tubes rotation, and when the nut cover of any tube is tight or release, other tube will not rotate together.

The advantages of the present invention are as following:

Compared with the prior tripods, the present invention applies trigger controlled opening and closing mechanism for adjusting quickly the leg opening angle to control the opening angle of the leg. The taper screw is tightly cooperated with the taper nut to limit the leg radial rotation. And the inner expanding type of locking mechanism between the tubes provides comparative locking force as the screw locking system of the prior tripods. The telescopic mechanism of the central axis enlarges the extension range of the legs and reduces the weight. The present invention is convenient for operation, light weighted, has a strong clamped force and a performance of security.

### BRIEF DESCRIPTION OF DRAWINGS

FIG. 1 is a perspective view of the tripod for camera according to the present invention;

FIG. 2 is a structure view of the tripod for camera according to the present invention;

FIG. 3 is an exploded view of the turntable of the tripod for camera according to the present invention;

FIG. 4 is a structure view of the turntable of the tripod for camera according to the present invention;

FIG. 5 is a structure view of the pothook of the tripod for camera according to the present invention;

FIG. 6 is an exploded view of the leg opening and closing mechanism of the tripod for camera according to the present invention;

FIG. 7 is a structure view of the leg opening and closing mechanism of the tripod for camera according to the present invention;

FIG. 8 is an exploded view of the elevator lever of the tripod for camera according to the present invention;

FIG. 9 is an exploded view of the leg of the tripod for camera according to the present invention;

FIG. 10 is a structure view of the inner expanding type of locking mechanism of the tripod for camera according to the present invention (portion I, II in FIG. 2);

FIG. 11 is a cross section view of the leg with carbon-fiber layers according to the present invention (circular);

FIG. 11A is a cross section view of the leg with carbon-fiber layers according to the present invention (octagon);

FIG. 11B is a cross section view of the leg with carbon-fiber layers according to the present invention (Inner: octagon; outer: circular);

FIG. 12 is a section view of the leg telescope locking mechanism according to the present invention.

### EMBODIMENTS

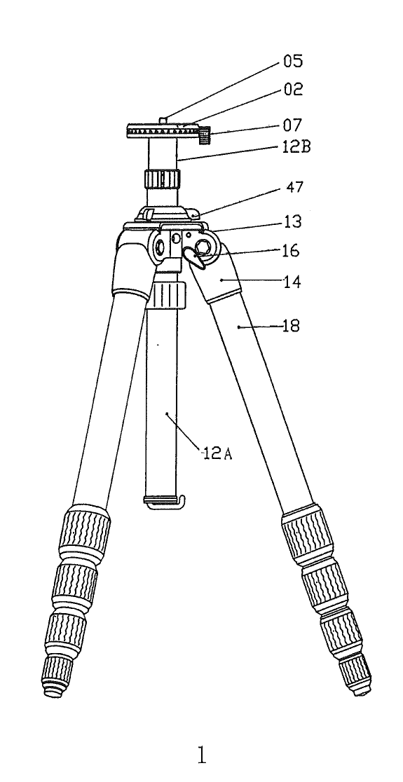

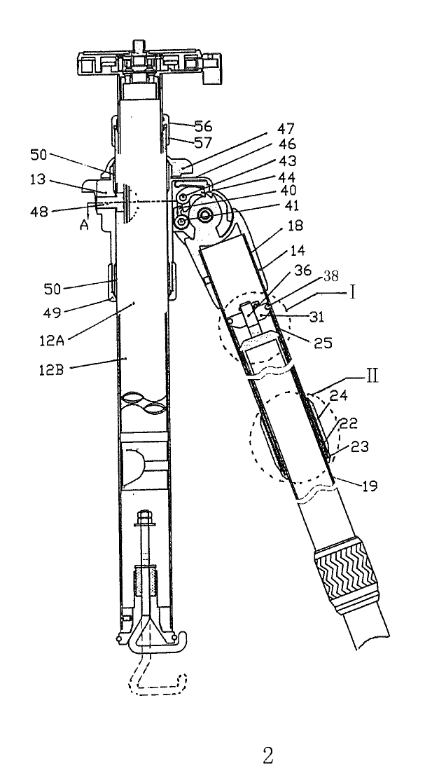

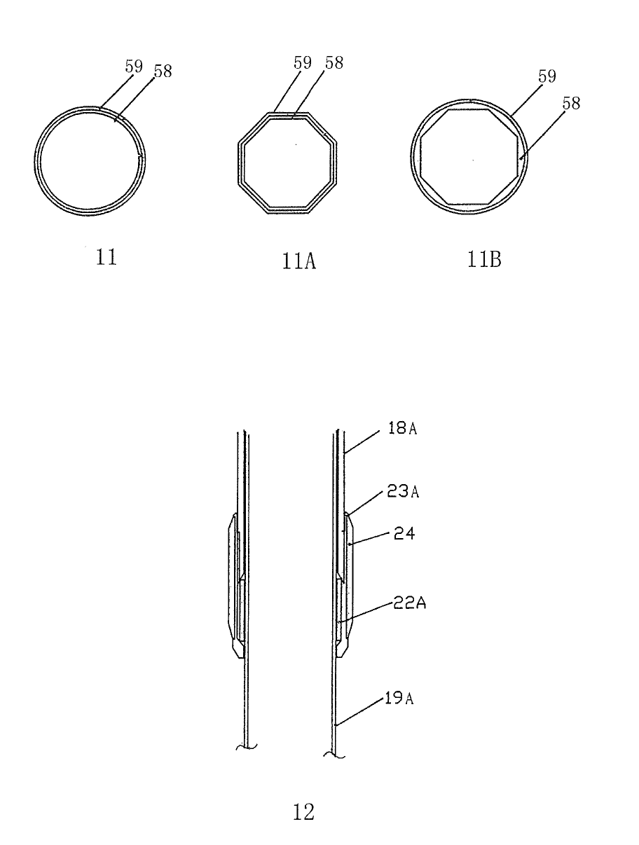

As shown in FIG. 1-12, the opening and closing mechanism is provided at the head of the tripod for camera in the present invention. The tube 18 installed on the tube base 14 connects with the tripod body 13. The central axis is consisted of two segments: elevator lever 12A and elevator lever 12B, wherein the central axis elevator lever 12B passes though tripod body 13. The nuts 57 for elevator levers are set in the upside of the tripod body 13. The turntable 02 is installed on the top of tripod, and there is a pothook 55 at the bottom of the elevator lever 12B.

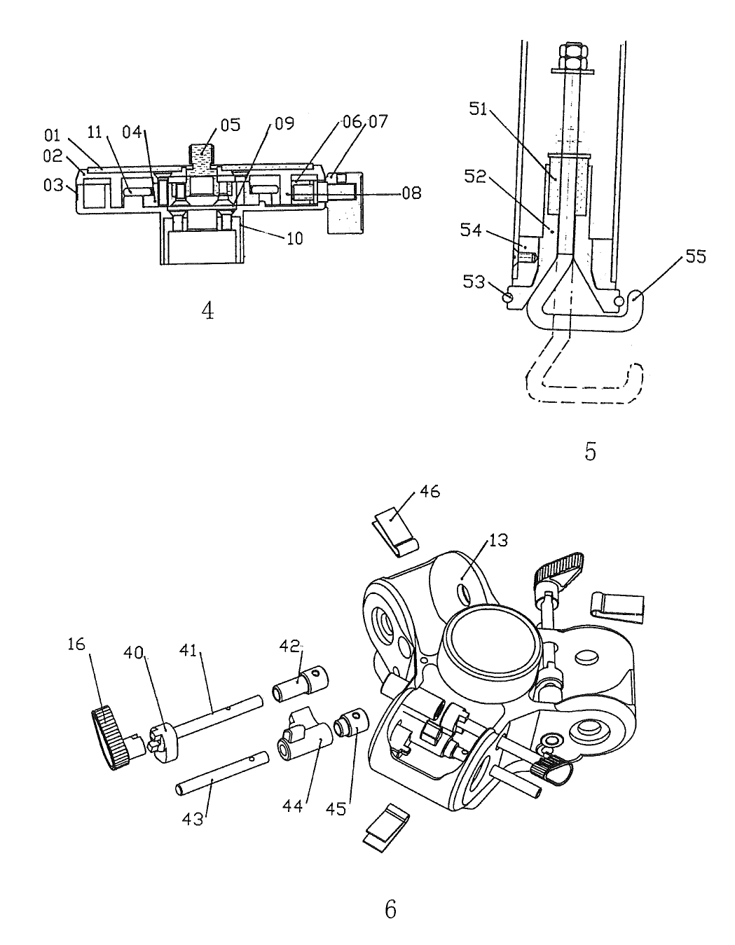

The opening and closing mechanism for adjusting the leg opening angle according to the present invention is shown in FIGS. 6 and 7. The pawl 44 is sheathed onto the pawl axis 43; and at the other end of the pawl axis, the wrap 45 for fixing the pawl is installed. The pawl axis 43 passes across the tripod body 13 horizontally and parallels with the rocker 40. The rocker 40 is installed in the end of the handle axis 41 and connected with the handle 16. At the other end of the handle axis 41, there is installed a wrap 42 for fixing the handle axis. The ratch engaged with the pawl is provided on the tube base 14. When need to open the tripod legs, first pull the handle 16, so the handle will drive the rocker 40 to put up the pawl 44 and make the legs dispread to a designated angle, the spring for the pawl 46 will push the pawl 44 back to the original status on the tube base 14, and prevent the tube from dispreading.

During operation of the tripod, the opening and closing mechanism for adjusting quickly the leg opening angle is controlled by trigger, pull the leg outward, the 1^{st} teeth of the ratch on the tube base 14 is limited by the pawl 44, and this is the most commonest angle. When larger dispread angle is required, push the handle 16, so that the rocker 40 and the heave gradient block provided on the pawl will turn to a moment wring, as a result the pawl 44 overcomes the spring resistance and opens up; at the same time pull the leg, and the dispread angle will enlarge to the next level; then release the handle, the pawl will be blocked on the 2^{st} teeth of the ratch with the help of the spring. Similarly, when the dispread angle needed to charge from large to small or needed to close entirely, just trigger the leg inside, because the ratch is designed with unilateral pawl, the pawl can be replace automatically at the same time.

The legs of the present invention are consisted of four segment tubes, as shown in FIG. 9. The tube 18 gets across tube base 14 and orientation wrap 15 to connect with tripod body 13. And a protective rubber sheath 24 is sheathed on the tube 18. Taper nut 31, 28 and 33 are provided respectively inside the tube 18, 19 and 20. On the bottom of the screw 36, 17 and 35 there are provided conical threads respectively. The taper screw in the tube joint is cooperated rotatablely with the taper nut within the tube. When the tube is installed, the top of the tube 18 sheathed inside the tube base 14; tube 19, 20 and 21 sheathed inside tube 18 in sequence with the help of screws 36, 17, 35 on the tube joint and the tube sheathes 25, 32, 34. The innermost tube 21 comes by an orientation ring 29 and sheath 34, then sheathes into tube 20; then tube 20 sheathes into tube 19, 18 in sequence. Tube sheath nuts 23, 26B, 29B are provided respectively at the end of the tube 18, 19 and 20 for connection and locking tightly. Tube plastic sheathes 24, 27 and 30 are provided respectively outside the nuts 23, 26B and 29B. At the end of the tube 21, a leg cap 37 is provided to ensure the tripod keeping balance on floor. Because the taper screw is cooperated rotatablely with the taper nut within the tube joint and the tube, during telescopic connection among the tubes 18, 19, 20 and 21, tube rotation can be limited, so when the nut cover of any tube is tight or release other tube will not rotate together.

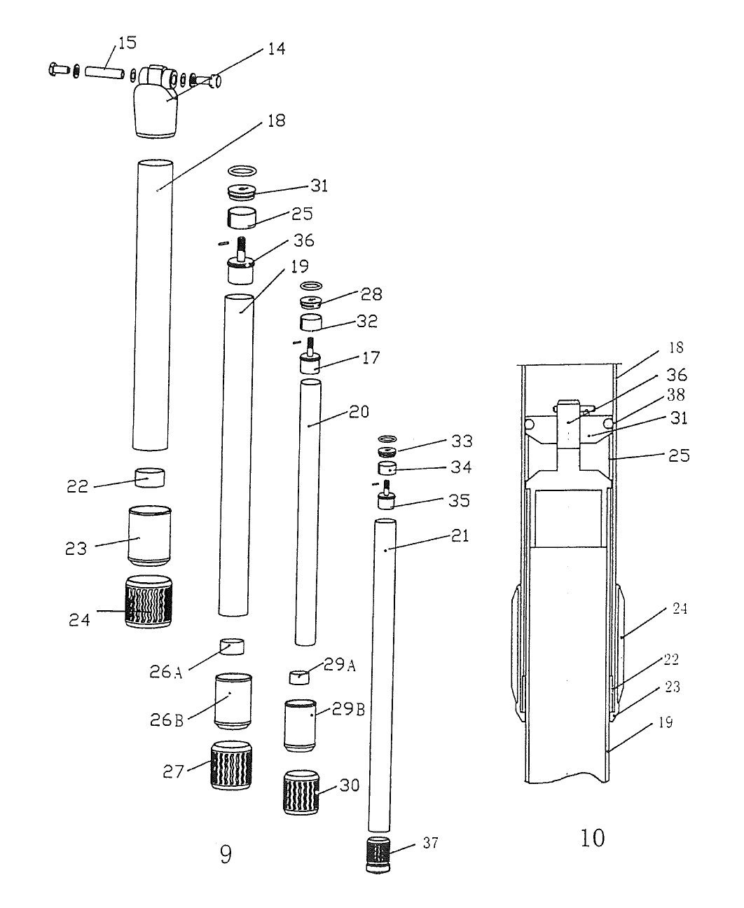

As shown in FIGS. 9 and 10, when the tube 19 rotates clockwise in relative to the tube 18, the screw 36 on the tube 19 rotates in synchronization. With the help of the friction between a rubber ring 38 and the tube 18, the nut 31 is inclined to keep still in relative to the tube 18, so rotates in relative to the tube 19. In the function of the threads, there is opposite rotation between the nut 31 and the screw 36, and the conical thread inside them makes a sheath 25 to inflate so as to press the inner wall of the tube 19, as a result the tube is locked tightly. In the locking status, when the two legs rotate inversely, the screw 36 also rotate contrary to the nut 31, so the conical thread will not press the sheath 25, the sheath will come back to original status, the two tubes will be in release status to open up. If the joints of multi-segments are in release status, the largest tube and the smallest tube will relatively rotate clockwise and continuously, and one of the joints will first complete the said locking movement, locking movement will be sequentially transferred to other joints till all of them are locked tightly.

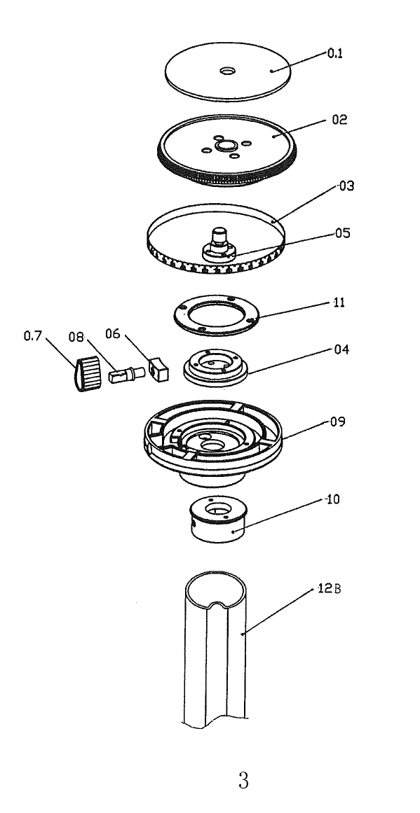

In the present invention, the turntable 02 with scale 03 is provided on the top of the tripod central axis, as shown in FIG. 3 and FIG. 4. The connecting screw 05 is installed onto the turntable housing 09 and covered with a washer 11, with the help of the connecting screw 05 fixes on the camera, the orientation ring 04 fixes the turntable to the turntable housing 09, a turntable mat 01 is mounted upon the turntable 02. The stem 07 is installed on the side of the turntable 02 and fixed onto the turntable by the stem screw 08 and the holder 06. The angle of the turntable rotation can be controlled by the stem. On the top of the elevator lever 12B within the central axis, the plug for elevator lever 10 is provided, and the turntable housing 09 is mounted upon it. The guide key-press 48 for the elevator level is provided in the elevator level so that the elevator level can lift and fall along it to adjust the height of the tripod. The locking nut 47 is installed upon the body 13 to lock the tripod tightly; the inner elevator level and the outer elevator level can be locked tightly by the elevator level nut 57, inner elevator level locking loop 56 and outer elevator level loop 50, locking nut 49 respectively.

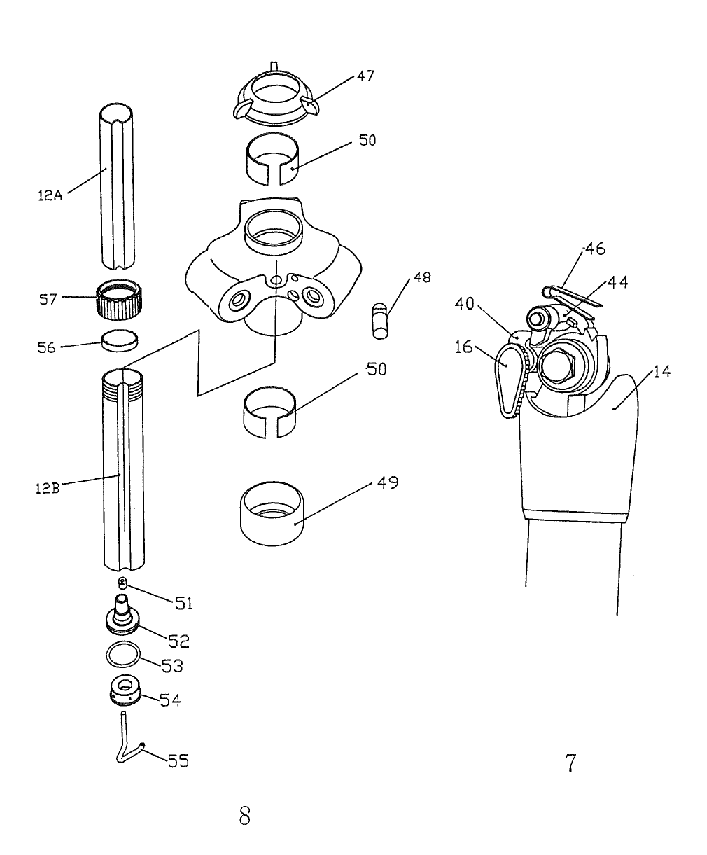

In the present invention, pothook 55 is provided on the bottom of the elevator level 12B, as shown in FIG. 8. The rubber sheath 51 is sheathed on the flying ring 52; and the plug for elevator level 54 clamps tightly the flying ring 52, fixed to the elevator level 12B by bolt. The straight part of the pothook 55 passes through the flying ring 52 and the rubber sheath 51 vertically. At the end of the pothook, nut is provided; the hook part of the pothook is extended out of the elevator level. The pothook can be pushed inward and hidden in the elevator level when it is in leisure; and pulled out to hang other things such as camera bag to increase the weight of the tripod when it is needed to use, so that the center of gravity for the tripod can be lower, which may help to keep the tripod in balance to be safe.

In the present invention, the surface of metal tube 58 of the tripod is wrapped with carbon fiber layer 59, which makes it more strengthen. The carbon fiber layer has strengthened the metal tube, also prevents the skin from sticking to the metal tube in cold weather. Besides, the central axis tube also can be wrapped with carbon fiber layer.

1-9. (canceled)

10. A tripod for camera comprises tripod body, tubes, tube bases, central axis, turntable, elevator level, pothook, the tube is installed in the tube base and connected to the tripod body, the elevator lever passes vertically through the tripod body center, the elevator nut is mounted upon the tripod body, wherein the opening and closing mechanism for adjusting the leg opening angle is provided between the leg tube base and the tripod body in the tripod, the inner expanding type of locking mechanism is provided between the tubes.

11. A tripod for camera according to claim 10, wherein said opening and closing mechanism for adjusting the leg opening angle comprises tripod body (13), pawl (44), pawl axis (43), wrap (45) for fixing the pawl, spring (46) for fixing the pawl, handle (16), rocker (40), handle axis (41), tube base (17); said pawl (44) is sheathed on said pawl axis (43), said wrap (45) for fixing the pawl is provided in the end of the pawl axis, the pawl axis (43) passes through the tripod body (13) horizontally and parallels with the rocker (40); the rocker (40) is at the end of the handle axis (41) and connected with the handle (16); the wrap (42) for fixing the handle axis is sheathed on the other end of the handle axis (41); the ratch cooperated with the pawl is provided on the tube base (14).

12. A tripod for camera according to claim 10, wherein in said inner expanding type of locking mechanism, the screw (36) connected tightly with the smaller one of the two adjacent tubes gets through the nut (31), the sheath (25) is installed between them and clings to the inner wall of the bigger one; conical thread is provided on the screw (36), and on the top of the screw (36) locking bolt is provided; conical thread is provided on the nut (31), rubber ring is provided out of the nut (31), fixing tip is provided on the top thereof; the tube can be locked or opened by rotating the cooperation of the taper screw (36) and the taper nut (31).

13. A tripod for camera according to claim 10, wherein in said inner expanding type of locking mechanism between tubes, the tube (18) connects with the tripod body (13) by means of tube base (14) and orientation wrap (15); the taper nuts (31), (28), (33) are provided inside the tubes (18), (19) and (20) respectively; the taper screws (36), (17), (35) are provided on the top of the tubes (19), (20), (21) respectively; the taper screw on the tube joint is cooperated rotatablely with the taper nut within the tube.

14. A tripod for camera according to claim 10, wherein the adjusting turntable (02) with scale (03) is provided on the top of the tripod central axis, the turntable is fixed on the turntable housing (09) with the help of orientation ring (04), and the withdrawing type of pothook (55) is provided on the bottom of the tripod central axis elevator level (12B).

15. A tripod for camera according to claim 10, wherein the straight part of said pothook (55) passes through the flying ring (52), the rubber sheath (51) and the plug for elevator level (54) vertically, and hangs on the flying ring (52); the rubber sheath is fixed on the flying ring (52); the plug (54) for elevator level clamps the flying ring (52) and installed on the elevator level (12B); the hook part of the pothook (55) can move up and down along the level.

16. A tripod for camera according to claim 14, wherein the straight part of said pothook (55) passes through the flying ring (52), the rubber sheath (51) and the plug (54) for elevator level vertically, and hangs on the flying ring (52); the rubber sheath is fixed on the flying ring (52); the plug (54) for elevator level clamps the flying ring (52) and installed on the elevator level (12B); the hook part of the pothook (55) can move up and down along the level.

17. A tripod for camera according to claim 10, wherein the central axis of the tripod has a telescopic construction of two or more segments.

18. A tripod for camera according to claim 14, wherein the central axis of the tripod has a telescopic construction of two or more segments.

19. A tripod for camera according to claim 10, wherein the section of said tubes is round or polygonal.

20. A tripod for camera according to claim 10, wherein the surfaces of both the metallic tubes and the central axis are covered with carbon fiber layers, which make them into carbon fiber strengthen metallic tubes.

21. A tripod for camera according to claim 19, wherein the surfaces of both the metallic tubes and the central axis are covered with carbon fiber layers, which make them into carbon fiber strengthen metallic tubes.
